(19) United States
(12) Patent Application Publication
(10) Pub. No.: US 2024/0141530 A1
(43) Pub. Date: May 2, 2024

(54) METHOD FOR PRODUCING COPPER COMPOSITE STRUCTURE, AND ENERGY STORAGE DEVICE AND SUBSTRATE STRUCTURE FOR RAMAN SCATTERING INCLUDING COPPER COMPOSITE STRUCTURE PRODUCED THEREBY

(71) Applicant: AJOU UNIVERSITY INDUSTRY-ACADEMIC COOPERATION FOUNDATION, Suwon-si, Gyeonggi-do (KR)

(72) Inventors: Chang-Koo KIM, Seoul (KR); Jun-Hyun KIM, Yongin-si (KR); Sanghyun YOU, Yongin-si (KR)

(73) Assignee: AJOU UNIVERSITY INDUSTRY-ACADEMIC COOPERATION FOUNDATION, Suwon-si, Gyeonggi-do (KR)

(21) Appl. No.: 18/288,502

(22) PCT Filed: Mar. 8, 2022
(86) PCT No.: PCT/KR2022/003241

§ 371 Date: Oct. 26, 2023

(30) Foreign Application Priority Data
May 12, 2021 (KR) 10-2021-0061126

(51) Int. Cl. C25D 1/00; G01N 21/65; H01G 11/26; H01M 4/02; H01M 4/04; H01M 4/38

(52) U.S. Cl. CPC C25D 1/003; G01N 21/65; H01G 11/26; H01M 4/0469; H01M 4/0471; H01M 4/38; H01M 2004/027

(57) ABSTRACT

A method for producing a copper composite structure is disclosed. The method for producing a copper composite structure includes a first step of forming a copper pillar structure; and a second step of annealing the copper pillar structure under a nitrogen atmosphere.

### FIELD

The present disclosure relates to a method for producing a copper composite structure having multi-scale structures, an energy storage device including the copper composite structure produced thereby, and a substrate for Raman scattering including the copper composite structure produced thereby.

### DESCRIPTION OF RELATED ART

Attempts are being made to achieve a high density and miniaturization of each of various electronic devices to improve performance thereof. Further, various studies are being conducted to improve the performance of each of the devices by controlling a shape of a fine structure.

An array of micro- or nano-sized copper pillar (column or rod) structures is used in various electronic devices. In particular, a multi-scale structure may be applied to a three-dimensional structure of each of a metal negative-electrode active material and a next-generation negative-electrode current collector in secondary batteries or super capacitors. When producing a substrate for Raman scattering, spectroscopy performance thereof may be improved by producing the multi-scale structure as a plasmonic nano-filler array.

There are many different producing methods of the array of micro- or nano-sized copper pillar structures. Korean patent numbers 10-1409387 and 10-1509529, etc. describe a method of fabricating an inclined or three-dimensional copper nanostructure using plasma etching.

The multi-scale structure is a mixture of micrometer-sized and nanometer-sized structures at the same time. The microstructure may control mechanical properties, and the nanostructure may control each of unique characteristics. Thus, the multi-scale structure may be applied to various fields such as electronics, optics, chemistry, microfluidics, and biomimetic technology.

However, a conventional technology does not have a method for fabricating multi-scale copper pillars with excellent specific surface area and mechanical properties in a large-area manner. In the conventional technology, the copper pillars are formed only in a single micro or nano size. Thus, performance increase is limited. Therefore, a control method of a shape of a copper pillar capable of multi-scale implementation is required to improve performance in various fields such as secondary batteries, super capacitors, substrates for Raman scattering, and hydrophilic surfaces.

### DISCLOSURE

### Technical Purpose

One purpose of the present disclosure is to provide a method for producing a multi-scale copper composite structure via a simple process such as nitrogen atmosphere annealing.

Another purpose of the present disclosure is to provide an energy storage device including the copper composite structure produced by the above method.

Still another purpose of the present disclosure is to provide a substrate for Raman scattering including the copper composite structure produced by the above method.

### Technical Solution

A first aspect of the present disclosure provides a method for producing a copper composite structure, the method comprising: a first step of forming a pillar copper structure; and a second step of annealing the copper pillar structure under a nitrogen atmosphere.

In one implementation of the method, the copper pillar structure is made of copper or an alloy thereof.

In one implementation of the method, in the first step, the copper pillar structure is formed by forming a template having a hole defined therein, and plating copper so as to fill the hole via electroplating or electroless plating.

In one implementation of the method, in the second step, the annealing is performed under a temperature condition of 360 to 420° C.

In one implementation of the method, in the second step, the annealing is performed for 30 to 90 minutes under a pressure condition of 1 to 5 Torr.

In one implementation of the method, the copper composite structure has a hybrid structure including the copper pillar structure of a microscale size and fine protrusions of a nanoscale size formed on a surface of the copper pillar structure.

A second aspect of the present disclosure provides an energy storage device including a copper composite structure as a negative-electrode active material thereof, wherein the copper composite structure has a hybrid structure including a copper pillar structure of a microscale size and fine protrusions of a nanoscale size formed on a surface of the copper pillar structure. In this case, the energy storage device may be a secondary battery or a super capacitor.

A third aspect of the present disclosure provides a substrate structure for Raman scattering comprising: a substrate for Raman scattering; and a plasmonic nano-filler array disposed on a surface of the substrate for Raman scattering, wherein the plasmonic nano-filler array includes a copper composite structure, wherein the copper composite structure includes a copper pillar structure of a micro-scale size and fine protrusions of a nano-scale size formed on a surface of the copper pillar structure.

### Technical Effect

According to the copper composite producing method in accordance with the present disclosure, the copper composite structure having multi-scale structures simultaneously may be produced in a very simple process. Furthermore, the copper composite structure produced by this method has a multi-scale hybrid structure in which the fine protrusions of a nanoscale size are formed on the surface of the copper pillar structure of a microscale size. Thus, the copper composite structure may have unique physical and chemical properties generated from the nanoscale protrusions along with excellent mechanical properties and a high specific surface area. As a result, the copper composite structure may be applied to various fields such as electronics, optics, chemistry, microfluidics, and biomimetic technology.

### BRIEF DESCRIPTION OF DRAWINGS

FIG. 1 is a flow chart for illustrating a method for producing a copper composite structure according to an embodiment of the present disclosure.

FIG. 2A and FIG. 2B are cross-sectional views to illustrate a template for producing the copper pillar structure and a producing process of the copper pillar structure using the same.

FIG. 2C is a diagram for illustrating change in surface morphology of the copper pillar structure due to an annealing process under a nitrogen atmosphere.

FIG. 3 shows SEM images of the copper pillar structure before annealing and the copper composite structure after annealing according to each of Comparative Example 1 and Present Examples 1 and 2.

FIG. 4 shows a SEM image of the copper composite structure after annealing according to each of Comparative Example 1 and Present Examples 1 and 2.

FIG. 5 shows top and side SEM images of the copper composite structure produced according to Present Example 1.

FIG. 6 is SEM images for illustrating an entire process of producing the copper composite structure according to Present Example 1.

### DETAILED DESCRIPTIONS

Hereinafter, embodiments of the present disclosure will be described in detail with reference to the accompanying drawings. The present disclosure may have various changes and may have various forms. Thus, specific embodiments are illustrated in the drawings and described in detail herein. However, this is not intended to limit the present disclosure to a specific disclosure form. It should be understood that the present disclosure includes all changes, equivalents, or substitutes as included within the spirit and technical scope of the present disclosure.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described under could be termed a second element, component, region, layer or section, without departing from the spirit and scope of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

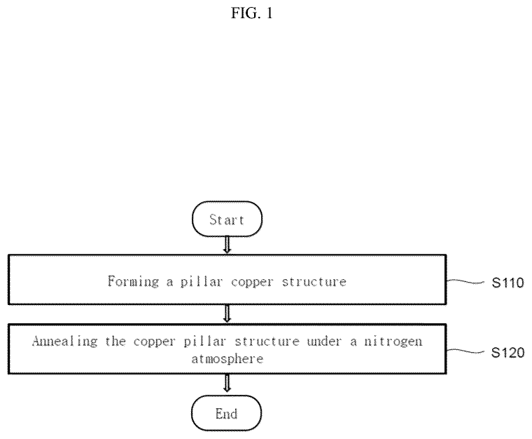

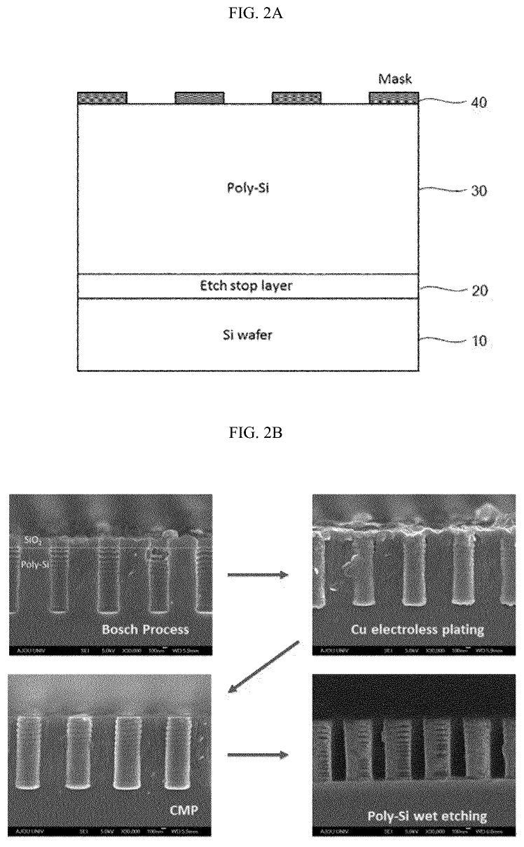

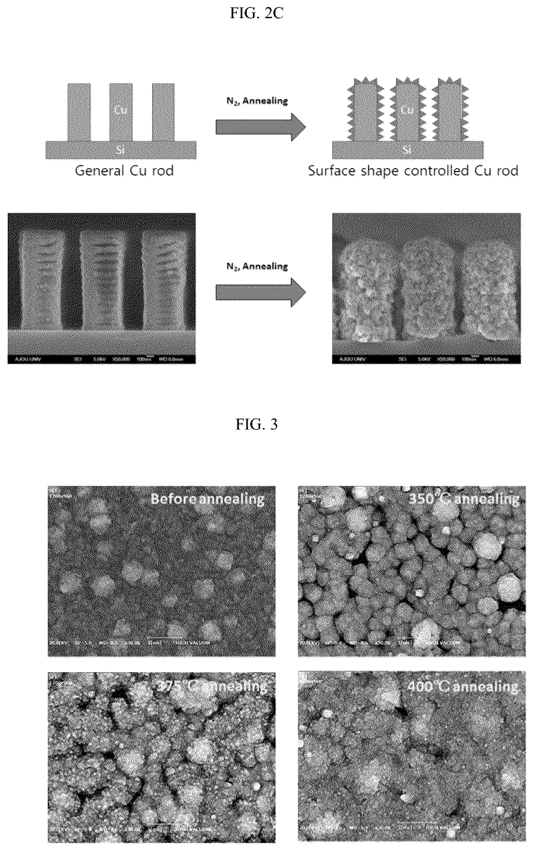

FIG. 1 is a flow chart for illustrating a method for producing a copper composite structure according to an embodiment of the present disclosure. FIG. 2A and FIG. 2B are cross-sectional views to illustrate a template for producing the copper pillar structure and a producing process of the copper pillar structure using the same. FIG. 2C is a diagram for illustrating change in surface morphology of the copper pillar structure due to an annealing process under a nitrogen atmosphere.

Referring to FIG. 1 and FIG. 2A to FIG. 2C, the method for producing the copper composite structure according to an embodiment of the present disclosure includes a first step S110 of forming the copper pillar structure; and a second step S120 of annealing the copper pillar structure under a nitrogen atmosphere.

In the first step S110, the copper pillar structure may be made of copper or an alloy thereof. A shape thereof is not particularly limited as long as a cross section thereof has a circular, polygonal or irregular shape and the pillar structure extends in one direction. In one example, a size of the cross section of the copper pillar structure may be constant or change depending on the location. In one embodiment, the copper pillar structure may have a cross-sectional size of several to tens of micrometers and a length of tens to hundreds of micrometers.

A scheme for forming the copper pillar structure is not particularly limited. In one embodiment, the copper pillar structure may be formed by a hydrothermal synthesis method or formed via an electroplating or electroless plating process using a template. In another embodiment, the copper pillar structure may be formed by forming a copper thin film and performing an etching process thereon.

In one embodiment, the copper pillar structure may be formed via a plating process using a template, as shown in FIG. 2A and FIG. 2B. For example, an etch stop layer 20 and an etch target layer 30 may be sequentially stacked on a support substrate 10, and then the etch target layer 30 may be anisotropically etched using a mask 40 such that a template in which a hole corresponding to the copper pillar structure is formed may be prepared. Then, the hole may be filled with copper via electroplating or electroless plating and then the mask 40 and the etch target layer 30 may be removed therefrom. In this way, the copper pillar structure may be formed.

In one embodiment, the support substrate 10 may be embodied as a silicon wafer, and the etch target layer 30 may be made of polysilicon. The etch stop layer 20 may be made of a material with a high etch selectivity relative to the material of the etch target layer 30, such as silicon oxide such as SiO₂, silicon nitride such as Si₃N₄, silicon carbide such as SiC, amorphous carbon, etc.

In one embodiment, the hole in the etch target layer 30 may be formed in an etching process such as a cyclic etch process or a gas chopping process. For example, the hole in the etch target layer 30 may be formed via the Bosch process, in which an etching step using a plasma such as SF₆ and a deposition step using a plasma such as C₄F₈ are alternately and repeatedly performed.

In one embodiment, the plating process for filling the hole may be performed via electroless plating. For example, the hole may be filled with copper by pre-treating a surface of the template using a first solution and then plating the surface thereof using the second solution. The first solution may include HF (hydrogen fluoride) at a concentration of about 4 to 6 ml/L, HCl (hydrochloric acid) at a concentration of about 2 to 4 ml/L, and PdCl₂ (palladium chloride) at a concentration of about 0.05 to 0.15 g/L. The content of HF (hydrogen fluoride) may be in a range of about 45 to 55 vol %, the content of HCl (hydrochloric acid) may be in a range of about 30 to 40 vol %, and the remaining balance may be PdCl₂ (palladium chloride). In one example, the second solution may be a basic aqueous solution including triton-X100 [2,2′-dipyridyl(2,2′-dipyridyl] (surfactant) at a concentration of about 4 to 6 ml/L, CuSO₄·5H₂O (copper sulfate) at a concentration of about 4 to 6 g/L, EDTA (ethylenediaminetetraacetic acid) at a concentration of about 14 to 16 g/L, HCHO (formaldehyde) at a concentration of about 4 to 6 ml/L, and 2,2′bipyridyl at a concentration of about 0.02 to 0.06 g/L. The electroless plating process using the second solution may be performed at about 85 to 90° C. for about 4 to 10 minutes.

In the second step S120, the copper pillar structure may be annealed for about 30 to 90 minutes under conditions of a temperature of about 360 to 420° C. and a pressure of about 1 to 5 Torr, and under a nitrogen atmosphere. Via this annealing process, as shown in FIG. 2C, protrusions having a size of nanoscale, for example, about several to tens of nm, may be formed on a surface of the copper pillar structure. As a result, the specific surface area of the copper pillar structure may be significantly increased.

A surface shape of the copper pillar structure, for example, a density, a size, and a shape of the nanoscale protrusions may be greatly affected by the annealing temperature and pressure. For example, when the annealing temperature is lower than 300° C., the fine protrusions may not be formed. When the annealing temperature exceeds 500° C., the size of the protrusions may become excessively large and, as a result, the specific surface area may not be significantly increased. In one example, when the pressure of the annealing process is lower than 1 Torr, the size of the protrusions may become excessively large, and as a result, a problem may occur in which the surface area is not significantly increased. When the pressure of the annealing process exceeds 5 Torr, a problem may occur in which the fine protrusions are not formed or are formed at a low density.

According to the copper composite producing method in accordance with the present disclosure, the copper composite structure having multi-scale structures simultaneously may be produced in a very simple process. Furthermore, the copper composite structure produced by this method has a multi-scale hybrid structure in which the fine protrusions of a nanoscale size are formed on the surface of the copper pillar structure of a microscale size. Thus, the copper composite structure may have unique physical and chemical properties generated from the nanoscale protrusions along with excellent mechanical properties and a high specific surface area. As a result, the copper composite structure may be applied to various fields such as electronics, optics, chemistry, microfluidics, and biomimetic technology.

In one embodiment, the copper composite structure may be applied as a negative-electrode active material for a secondary battery or a super capacitor. In this case, the copper composite structure as a copper metal-based negative-electrode active material has high energy density and may significantly improve the performance of the negative-electrode material due to its high specific surface area.

In another embodiment, the copper composite structure may be applied, as a plasmonic nano-filler array, to a substrate for Raman scattering to significantly improve the spectroscopy ability of the substrate for Raman scattering.

In still another embodiment, the copper composite structure has hydrophilic surface properties, and thus may be applied as a hydrophilic surface coating.

Examples of the present disclosure are described in detail below. However, the Examples below are only some embodiments of the present disclosure, and the scope of the present disclosure is not limited to the Examples below.

### Comparative Example 1, Present Examples 1 and 2

A silicon oxide film and a polysilicon layer were sequentially formed on a silicon wafer, and then, a hole is formed in the polysilicon layer via the Bosch process using a mask, and then, copper was plated to fill the hole in the polysilicon layer using an electroless plating process.

Subsequently, an over-plated copper was removed therefrom via a polishing process, and then the mask and the polysilicon layer were removed therefrom to manufacture the copper pillar structure.

Subsequently, a copper composite structure of each of Comparative Example 1 (350° C.), Present Example 1 (375° C.), and Present Example 2 (400° C.) was produced while changing the annealing temperature as shown in Table 1 below.

TABLE 1

| Annealing | | | |
|---|---|---|---|
| Temperature | Pressure | N₂ flow rate | Annealing time |
| (° C.) | (Torr) | (sccm) | (min) |
| 350, 375, 400 | 1 | 500 | 60 |

### Comparative Examples 2 to 4, and Present Examples 3 to 5

The copper pillar structure has been produced in the same way as in each of Present Examples 1 to 2, and then, a copper composite structure of each of Comparative Example 2 (0.2 Torr), Comparative Example 3 (0.5 Torr), Present Example 3 (1.0 Torr), Present Example 4 (5.0 Torr), Present Example 5 (50.0 Torr), and Comparative Example 4 (250.0 Torr) was produced while changing the pressure of the annealing process, as shown in Table 2 below.

TABLE 2

| Annealing | | | Annealing |
|---|---|---|---|
| Temperature | Pressure | N₂ flow rate | time |
| (° C.) | (Torr) | (sccm) | (min) |
| 375 | 0.2, 0.5, 1, 5, 50, 250 | 500 | 60 |

### Experimental Example

FIG. 3 shows SEM images of the copper pillar structure before annealing and the copper composite structure after annealing according to each of Comparative Example 1 and Present Examples 1 and 2.

Referring to FIG. 3, the copper pillar structure before annealing under a nitrogen atmosphere had a form of a copper thin film in which copper particles are agglomerated with each other.

According to Comparative Example 1, the copper pillar structure annealed at 350° C. had the protrusions sparsely on the surface thereof, but exhibited no significant change.

According to Present Example 1, fine-sized protrusions were densely formed on the surface of the copper pillar structure annealed at a temperature of 375° C., and the fine protrusions covered the entire surface of the copper pillar structure. As a result, the surface of the copper pillar structure after the annealing was formed to be rougher than before annealing.

According to Present Example 2, fine protrusions were formed on the surface of the copper pillar structure annealed at a temperature of 400° C., but the size of the fine protrusions was found to be smaller than that of the copper composite structure of Present Example 1. This is because a portion of the fine protrusions melted and crumbled due to the increase in the annealing temperature.

Considering the above results, it is determined that the annealing temperature for the copper pillar structure is preferably in a range of about 360° C. inclusive to 420° C. inclusive.

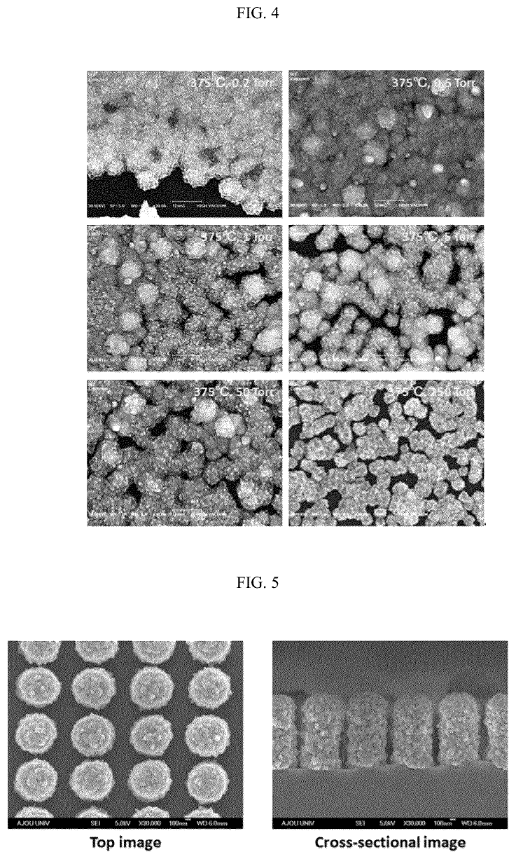

FIG. 4 is the SEM images of the copper composite structure after annealing according to each of Comparative Example 1, Present Example 1, and 2, and FIG. 5 shows top and side SEM images of the copper composite structure produced according to Present Example 1.

Referring to FIG. 4 and FIG. 5, it was identified that in Comparative Example 2 (0.2 Torr) and Comparative Example 3 (0.5 Torr) where the pressure of the annealing process was relatively low, the surface of the copper pillar structure became rougher than before annealing, but no fine protrusions were formed. Furthermore, it was identified that in the Comparative Example 4 (250 Torr) where the pressure of the annealing process was relatively high, no protrusions were visible on the surface of the copper pillar structure, and the copper pillar structures was simply separated from each other under the heat of the temperature.

On the contrary, it was identified that in the copper composite structures of Present Example 3 (1 Torr) and Present Example 4 (5 Torr), fine protrusions clearly appeared on the surface of the copper pillar structure. In particular, the protrusions appeared most clearly in Present Example 3. It was identified that in the copper composite structure of Present Example 4, the density of fine protrusions on the surface of the copper pillar structure was slightly lower than that of Present Example 3. Although the fine protrusions were formed in Present Example 5 (50 Torr), a density thereof was found to be lower than that of each of Present Examples 3 and 4.

Considering the above results, it is determined that the annealing process is preferably performed at a pressure of about 0.9 to 50 Torr, preferably at a pressure of about 0.9 to 5 Torr.

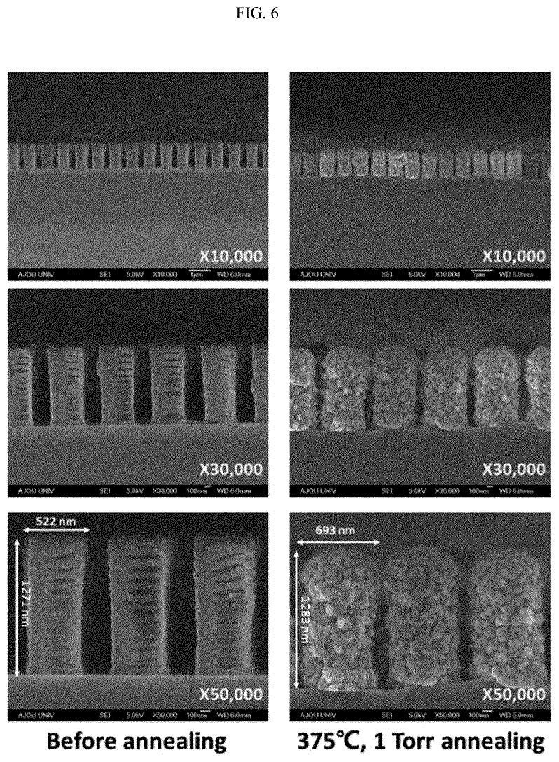

FIG. 6 is SEM images for illustrating the entire process of producing the copper composite structure according to Present Example 1.

Referring to FIG. 6, the copper pillar structure before annealing had a diameter of 522 nm and a length of 1271 nm, but the copper composite structure after annealing had a diameter of 693 nm and a length of 1283 nm. In other words, there was almost no change in the length of the copper pillar before and after annealing, but the diameter thereof increased by about 170 nm due to the formation of protrusions after the annealing. Before the annealing, the surface of the copper pillar structure was relatively smooth, while after the annealing, fine protrusions of tens of nanometers in size were formed on the surface of the copper pillar structure.

The present disclosure has been described above with reference to a preferred Present Example, but those skilled in the art may modify and change the present disclosure in various ways without departing from the spirit and scope of the present disclosure as set forth in the patent claims below.

What is claimed is:

1. A method for producing a copper composite structure, the method comprising:
a first step of forming a pillar copper structure; and
a second step of annealing the copper pillar structure under a nitrogen atmosphere.

2. The method of claim 1, wherein the copper pillar structure is made of copper or an alloy thereof.

3. The method of claim 1, wherein in the first step, the copper pillar structure is formed by forming a template having a hole defined therein, and plating copper so as to fill the hole via electroplating or electroless plating.

4. The method of claim 1, wherein in the second step, the annealing is performed under a temperature condition of 360 to 420° C.

5. The method of claim 4, wherein in the second step, the annealing is performed for 30 to 90 minutes under a pressure condition of 1 to 5 Torr.

6. The method of claim 1, wherein the copper composite structure has a hybrid structure including the copper pillar structure of a microscale size and fine protrusions of a nanoscale size formed on a surface of the copper pillar structure.

7. An energy storage device including a copper composite structure as a negative-electrode active material thereof, wherein the copper composite structure has a hybrid structure including a copper pillar structure of a microscale size and fine protrusions of a nanoscale size formed on a surface of the copper pillar structure.

8. The energy storage device of claim 7, wherein the energy storage device includes a secondary battery or a super capacitor.

9. A substrate structure for Raman scattering comprising:
a substrate for Raman scattering; and
a plasmonic nano-filler array disposed on a surface of the substrate for Raman scattering,
wherein the plasmonic nano-filler array includes a copper composite structure, wherein the copper composite structure includes a copper pillar structure of a micro-scale size and fine protrusions of a nano-scale size formed on a surface of the copper pillar structure.
